(19) United States
(12) Patent Application Publication
(10) Pub. No.: US 2016/0267576 A1
(43) Pub. Date: Sep. 15, 2016

(54) System and Method for Controlling and Sharing Online Images of Merchandise

(71) Applicant: RYCROSS, LLC D/B/A SEELTFIT, Atlanta, GA (US)

(72) Inventors: SARAH CROSSMAN SULLIVAN, Atlanta, GA (US); JAMIE R. PENNINGTON, Atlanta, GA (US)

(73) Assignee: RyCross, LLC d/b/a SeeltFit, Atlanta, GA (US)

(21) Appl. No.: 15/034,208

(22) PCT Filed: Nov. 4, 2014
(86) PCT No.: PCT/US14/63808

§ 371 Date: May 4, 2016

Related U.S. Application Data
(60) Provisional application No. 61/899,334, filed on Nov. 4, 2013.

(51) Int. Cl. G06Q 30/06; G06T 19/00

(52) U.S. Cl. CPC G06Q 30/0643; G06T 19/006

(57) ABSTRACT

A system and method that enable online consumers to create unique user-generated content based on photographs of sought after items, such as retail merchandise. Targeted items may include a myriad of products, including art, furniture, paint, real estate, home decor, medical supplies, healthcare, jewelry, automobiles, etc. Images which include clothing may be processed so that a user may select items to create a compilation image of a virtual outfit superimposed over the user's image. A virtual outfit may include multiple items, such as various garments and accessories, and may be modified by adding, removing and layering items. Multiple compilations may be saved and compared in order to assist in the purchase decision making process. Compilations may be shared online in order to implement a virtual shopping experience and obtain feedback and critiques. Analytics may be utilized to forecast fashion trends based on consumer input concerning the pairing of products.

This non-provisional patent application claims priority to, and incorporates herein by reference, U.S. Provisional Patent Application No. 61/899,334 filed on Nov. 4, 2013.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The presently disclosed invention relates in general to the field of controlling online images of merchandise, and in particular to a system and method for enabling consumers to capture, adjust, display and share online images of goods in a personalized manner.

### BACKGROUND OF THE INVENTION

Systems for virtually previewing clothing desired to be worn by a user are known in the art. Basic techniques for the dynamic viewing of articles via video images have been described in U.S. Pat. No. 4,539,585. Technology for applications that implement virtual dressing rooms is described in U.S. Pat. No. 8,275,590. These publications are incorporated herein by reference. User video-feed systems, however, are problematic for users located in environments not suitable for capturing requisite videos and for users without video-capturing capabilities. Further, the image information for an article to be previewed, and the seller-generated information associated with articles, may require specific agreements, software programs and tools to be utilized by online sellers in order to implement a virtual shopping experience. Embodiments of the presently disclosed invention address such limitations, inter alias, by providing an improved online-shopping system and method that enable consumers to see, shop and share while remaining on a single website or app.

### SUMMARY OF THE INVENTION

Embodiments of the disclosed system and method enable images to be retrieved from various retailer websites and processed so that the images may be placed over other images to create unique user-generated content. Such content may include the image of a person, clothing, accessories, a room, a landscape, etc. As such, the present system and method enables consumers to virtually try on clothes. Certain embodiments may include content relating to weight loss, healthcare equipment, furniture, fine art, real estate, cosmetic surgery, and health and wellness. In some embodiments, a comparison feature may be included which allows a user to view a side-by-side comparison of merchandise to evaluate two or more “looks” that were created by the user to assist in the purchase decision making process.

### BRIEF DESCRIPTION OF THE DRAWINGS

The foregoing and other objects, features, and advantages of the invention will be apparent from the following more particular description of embodiments as illustrated in the accompanying drawings, in which reference characters refer to the same parts throughout the various views. The drawings are not necessarily to scale, emphasis instead being placed upon illustrating principles of the invention.

FIG. 1 is a flow chart of an example of a method for controlling online images including the steps for generating an image of an item or product, in accordance with certain embodiments of the invention.

FIG. 2 is a flow chart of an example of a method for controlling online images including the steps for superimposing an item image over a second image, in accordance with certain embodiments of the invention.

FIG. 3 is a flow chart of an example of a method for controlling online images including the steps for rendering a side-by-side comparison of two user-generated compilation images, in accordance with certain embodiments of the invention.

FIG. 4 is a flow chart of an example of a method for controlling online images including the steps for superimposing two item images over a second image, in accordance with certain embodiments of the invention.

FIGS. 5(a) and 5(b) show an item image, a second image and a compilation image, in accordance with certain embodiments of the invention.

FIG. 6 illustrate a side-by-side comparison of two compilation images for evaluating potential purchases, in accordance with certain embodiments of the invention.

### DETAILED DESCRIPTION OF THE EMBODIMENTS

Reference will now be made in detail to the embodiments of the presently disclosed invention, examples of which are illustrated in the accompanying drawings.

One of the objects for embodiments of the present system and method may be an application in which consumers may view images of clothes superimposed upon photographs of themselves while shopping online at home, or anywhere else in life where an Internet connection is available, before buying the clothes. A benefit of such an embodiment is that consumer would make more confident buying decisions, thereby increasing conversion rates and decreasing returns. There is a growing need to improve the shopping experience online and in-store as more professionals, and at-home parents with young children, lack the time for in-store shopping. The capability of having consumers see clothes and/or other items superimposed over their own photographs before they buy an item is a critical improvement to the fashion industry.

The object for certain embodiments may concern such an application which enables the combination of searching for, and viewing, images of apparel online (whether two-dimensional or three-dimensional images); personalization of ecommerce; solutions provided in ecommerce verticals beyond fashion; photo sharing; and, social sharing. Embodiments may not be limited, however, to any one application, example or object. The embodiments may be applicable in virtually any application in which an image of an item is available via the Internet. In addition to pulling together an outfit, a room may be designed via certain implementations of the invention. The embodiments of the present system and method are well suited for implementation in a myriad of verticals, including: art, furniture, paint, real estate, home decor, medical supplies, healthcare, jewelry, automobiles, cloth dynamics and more.

In some embodiments, the invention addresses the problem of the lack of personalization in ecommerce. Individuals could not shop online for items on a website and “see” what they are purchasing for themselves or those they shop for via the website. Embodiments provide for unique visualization and personalization of online shopping so that consumers can see how garments fit and/or look from the comfort of their home or anywhere they have online access. The determination of what “fits” may be based on how an item or outfit “fits” a style, event or wardrobe. Additionally, in some embodiments, users may provide their body measurements or preferred item size so that a retailer or manufacturer may be notified of the opportunity to offer an item with a particular size or tailoring based on a user's size recommendation. In certain embodiments, consumers may use their smart phone, tablet or personal computer to readily access an app, website or use technology through a retail partner's website or app.

In certain embodiments, social sharing functionality allows users to share a photograph of themselves, or someone else, along with the image of the garment (a “look”) with friends and family members that they shop for and/or shop with. Users can share one or more look(s) with someone in their own home or someone who lives across the country. Thus, a young woman in college at NYU can share her “look” with her mom who lives in Atlanta or friends that live in Seattle. When deciding between two or more “looks,” a user may share multiple user-generated compilation images of the user “trying on” various virtual garments. Side-by-side comparisons of two or more compilation images may be presented to other members via the social sharing functionality in order to improve the virtual shopping experience and the purchase decision making process.

In an embodiment, individuals that users can share with may be grouped in an application as friends and family. Users may readily share a “look” in some embodiments via Facebook, Twitter, email, etc. In addition, users may share with a small group or with one individual within one of their online communities. Accordingly, such social sharing aspects of images and feedback on those images provide a personalized ecommerce experience.

In addition to shopping online, in one embodiment, a consumer may find clothing items in-store and scan the Universal Product Codes (UPC) or barcodes found on the clothing tags with a smart phone and then view an image of the item superimposed upon a picture of the consumer on their smart phone. Such an implementation may save consumers the time spent on physically trying on the clothes. Also, users may scan UPC tags in-store via their smart phones and then see the item over another's photograph via an application on their smart phone. For example, a mom may view a dress in a store she thinks may look nice on her daughter. She can scan the UPC code and then see the dress on a picture of her daughter. She can then share the image with her daughter and get feedback on whether to make the purchase or not. Additionally, in some embodiments, users may scan the UPC code for various items while walking around in a store and view side-by-side comparisons of two or more compilation images so that users may decide between “looks” without needing to physically walk back to a previously viewed item.

Existing solutions for merely posting or sharing images of items fail to allow users to create their own “look” by seeing how items might look on images of themselves. Style boxes that are used in the retail industry to present items without a user's image have a limited functionality, such as the pinning approaches used by Pinterest. When compared to personalization in ecommerce, such techniques result in consumers lacking confidence in making buying decisions. Utilization of style boxes for items along with the ability of viewing items on a user's own image contributes to an increased buying confidence and gamification aspects, where users can lose themselves in creating style boxes and viewing items on their own images. In embodiments of the present invention, consumers can easily click on a “See” button or simply drag an item over from a partnered retailer's site and use tools to see the item. Use of certain tools is not contingent on a retail partnership. Consumers will readily be able to “see” clothes on an image of themselves by shopping for retailer products via a service provider's website or app. In addition, users can upload a picture of themselves and then immediately begin shopping for various retail products. While staying on the service provider's website, users can view retail seller's websites and select specific items to move into their “closet” in the service provider's website. At any time, users can “try on” those items by going to a “Try On” area in the service provider's website. If a user has not uploaded a picture of themselves, they can use a default profile picture provided by the service provider. In addition, users can then share their “looks” for immediate feedback from friends and family.

Prior approaches relied upon by Instagram, Tumblr, Snap Chat and Polyvore also fail to provide personalization in ecommerce. In an embodiment, the social sharing aspects empower users to get feedback on whether to make a singular or layered (multiple item) buying decision. The feedback can come from a broad social aspect, such as seeking input from all of their friends on Facebook. Users may also seek opinions from a smaller online community, including a community controlled or managed by the user via the service provider's application or website. Such a community may be designed to be the user's friends that the user would shop for, or shop with, even if they live across the state or across the globe.

The feedback on an item(s) a user has viewed using an embodiment may be provided in real-time before purchase. In certain embodiments, the feedback features may include voice technology, such as verbal reactions to visual cues that are readily processed, received and shared.

In some embodiment, further retail offerings may be provided so that the service provider's website can become the user's online aggregator for shopping. The offerings may cross all verticals, and may include a “personal mall” with the user's favorite designers and stores (such as Ralph Lauren, Home Depot, Sherwin Williams, Restoration Hardware, Realtor.com). Embodiments may further the 3D and other visual rendering offerings (including voice technology offerings) so that any item online can be viewed via an implementation.

In an embodiment, the application may allow users to draw marks on an image of an item to designate foreground and background parts of the image through a browser using HTML5 canvas. The application may then communicate via websockets with a server, on which a grab-cut or a graph-cut algorithm may be run to extract the full foreground objects from the image. The application may work asynchronously such that no browser refresh is required, and the user can refine the result by applying additional foreground, background marks as needed.

In certain embodiments, the following libraries may be used: the gevent-socketio library, which enables real-time communication between a browser and a server; the socket.io client library, which real-time bidirectional event-based communication; and, the simpleCV library, which enables computer vision applications. Such general web and app technology is known in the art, and related information can be found at the websites for GitHub, Inc. and the Django Software Foundation.

In one embodiment, a method for controlling online images may include the initial step of requesting a webpage from a server via a browser. The server may return an html-page with the respective image, and may then load that image into the drawing canvas such as a program, app, or browser window that is capable of displaying images. Upon receiving the webpage, a websocket connection may then be initiated by the client with the server. This server may be the client server. The websocket connection may use the gevent-socketio library and socket.io client library.

After the websocket connection is established, the client may send a request to the server with an image id, the server may then fetch the respective image (Original Image) and load it into memory. The server may also create a grayscale User Mask image of the same dimensions as the original image. This step may be performed by using the simpleCV library.

The user may then make a mark on the image of the item on the drawing canvas in the client browser. The x,y coordinates of the mark and the corresponding action (foreground, background, erase) may be sent to the server via websocket (the command). Upon receiving the command, the server may draw the respective mark on the User Mask: white for foreground, black for background, grey for unknown. The User Mask and Original Image may then be used in a Grab Cut (also known as Graph Cut) algorithm to calculate the resulting binary large objects (result blobs) indicating the foreground areas. This step may be performed by using the simpleCV library.

The blobs may then be combined into a single foreground blob. The foreground blob may then be applied as a mask to the original image, resulting in a result image with only the Foreground visible, and the background set to transparent. The contour of the foreground may then be calculated using the simpleCV findBlobsFromMask method. The new result image may be saved to the database. The server may then transmit the result image, the contour of the item, and the image of only the item back to the client. Upon receiving the results, the client browser may draw the result mask image to a result canvas, and may draw the item image to the drawing canvas. This process may be repeated until the user is satisfied with the result.

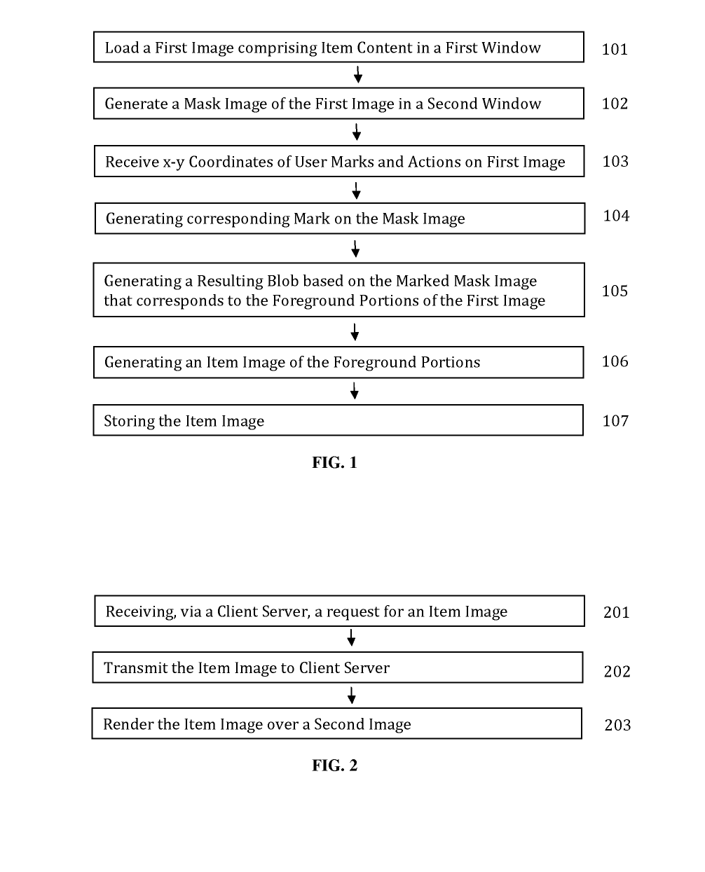

The presently disclosed invention may be embodied in various forms, including a system, a method or non-transitory computer readable medium for controlling online images. FIGS. 1-4 illustrate various steps for a method in accordance with certain embodiments of the invention, as further described below. These illustrated implementations represent only a few example flow charts, which are presented for descriptive purposes.

In an embodiment, images of items may be made available from various websites. Such images may contain background content 1 in addition to item content 2. For example, the sought after item might be a dress. As may be permitted by the owner of the targeted image, unwanted background content 1 (such as images of the surrounding scenery and the model wearing the dress) may be cut or clipped out. As such, the method may include the step of loading (101) a first image 3 in a first window 4. The first image 3 may comprise the item content 2 and background content 1. A mask image 5 of the first image 3 may be generated, per step 102. The mask image 5 may be displayed in a second window 6 adjacent to the first window 4. The mask image 5 may be grayscale and may have dimensions corresponding to the first image 3.

Embodiments of the method may include the step of receiving (103) x-y coordinates 7 of user marks and user actions performed on the first image 3 in the first window 4. The method may also include the step of generating (104) corresponding marks 8 on the mask image 5 in the second window 6. The corresponding marks 8 may be based on the x-y coordinates 7 of the user marks and the user actions performed on the first image 3. The corresponding marks 8 may comprise a first color corresponding to foreground portions 9 of the first image 3, and the corresponding marks 8 may further comprise a second color corresponding to background portions 10 of the first image 3.

In an embodiment of the method, one or more resulting blob(s) 11 may be generated (105) based on the marked mask image 12. The one or more resulting blob(s) 11 may correspond to the foreground portions 9 of the first image 3. A graph-cut algorithm may be executed based on the marked mask image 12 to calculate the one or more resulting blob 11 corresponding to the foreground portions 9 of the first image 3. The method may include the step of generating a result image 13 based on the one or more resulting blob(s) 11 and the first image 3. The one or more resulting blob(s) 11 may be applied as a mask to the first image 3. The result image 13 may render only the foreground portions 9 of the first image 3. The background portions 10 of the first image 3 may be hidden, masked or transparent.

Further, in such embodiments, the method may include the step of generating (106) an item image 14 for the foreground portions 9 of the first image 3. The foreground portions 9 may correspond to the item content 2 in the first image 3. As such, the item image 14 may comprise only the item content 2. In some embodiments, the method may include the step of storing (107) the result image 13 and the item image 14.

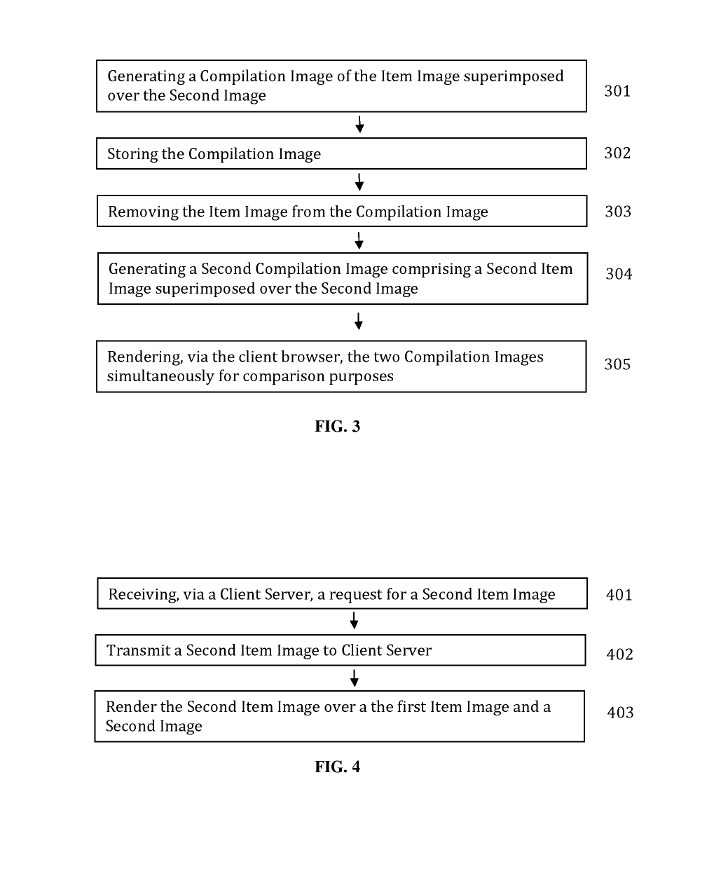

In certain embodiments, the item content 2 may comprise a garment. However, in accordance with other embodiments, the item content 2 may comprise any item that can be shown in an image. Further, as illustrated in FIG. 2, the method may include the step of receiving (201), from a client server 15, a request for an item or an image of the item. The item image 14 may be associated with, or depict, the item content 2. For example, an online search for certain item content 2 may result in the item image 14. The method may include the step of transmitting (202) the item image 14 to the client server 15. The item image 14 may comprise the item content 2. In addition, the method may include the step of rendering (203) the item image 14 via a client browser 16. The item image 14 may be adapted to be repositioned within the client browser 16, and the item image 14 may be further adapted to be superimposed over a second image 17.

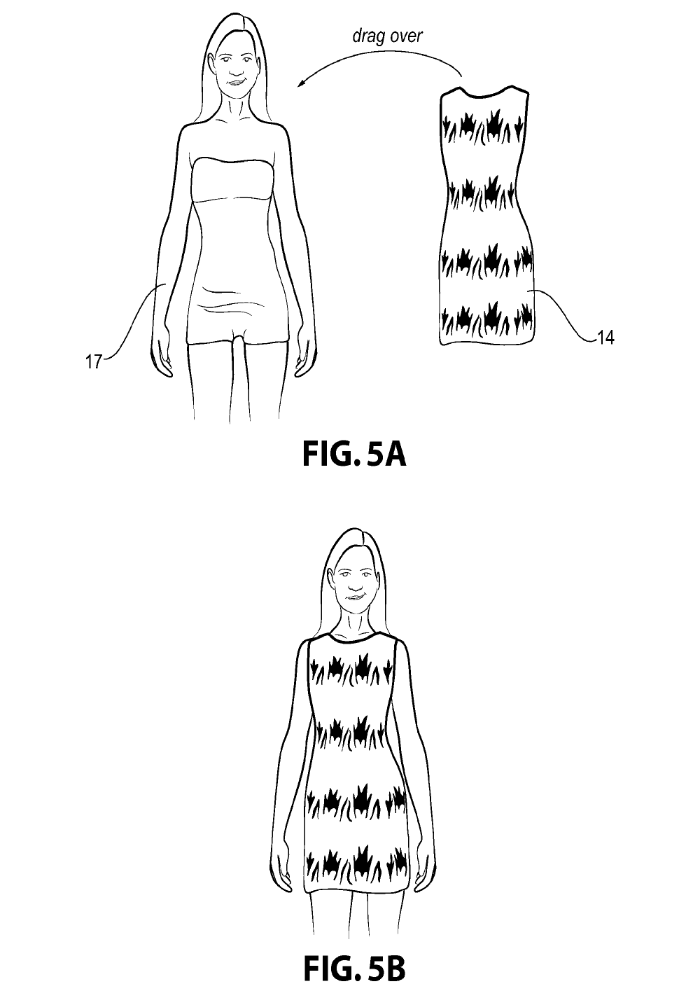

The second image 17 may be a photograph of a person, in accordance with certain embodiments. As illustrated in FIG. 3, the method may further include the step of generating (301) a compilation image 18, which may comprise user-generated content and may comprise the item image 14 superimposed over the second image 17. For example, an image of a dress may be superimposed over a user's photo. FIG. 5(a) illustrates examples of an item image 14 and a second image 17. The item image 14 may be rendered or superimposed over the second image 17 to generate a compilation image 18 as shown in FIG. 5(b), so that the user may view the compilation image 18 in the client browser 16. Further, the method may include the step of transmitting the compilation image 18 to one or more users. The method may also include the step of receiving feedback from one or more users. The feedback may comprise a fashion critique of the item content 2 or the “look” of the item shown with the user in the compilation image 18.

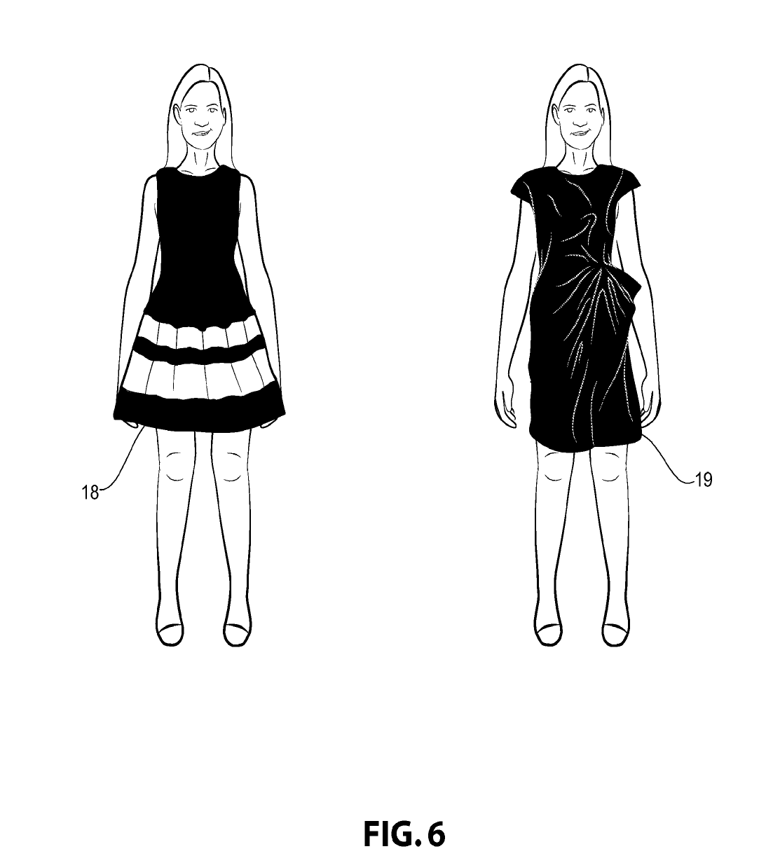

The compilation image 18 may comprise two or more layers. The first layer may be the item image 14, and the second layer may be the second image 17. In certain embodiment, the layers may be adapted to be capable of separation into two or more independent images, i.e. the item image 14 and the second image 17. As such, compilation images 18 may be assembled, disassembled, and reassembled with different item content 2. Referring back to FIG. 3, the method may include the step of storing (302) the compilation image 18. In addition, the method may include the removal (303) of the item image 14 from the compilation image 18, and the generation (304) of a second compilation image 19. The second compilation image 19 may comprise a second item image 20 superimposed over the second image 17. Accordingly, the second item image 20 may be adapted to be superimposed over the second image 17. Additionally, the method may include the step of rendering (305), via the client browser 16, the stored compilation image 18 adjacent to the second compilation image 19. The two compilation images may be simultaneously viewed for comparison purposes, as illustrated in FIG. 6.

In some embodiments, multiple item content 2 may be viewed together with the second image 17. The method may include the step of receiving (401), via a client server 15, a request for a second item or a second item image 21. The second item image 21 may be associated with, or depict, a second item content 22. The method may include the step of transmitting (402) a second item image 20 to the client server 15. The second item image 20 may comprise the second item content 22. Additionally, the method may include the step of rendering (403) the second item image 20 via a client browser 15. The second item image 20 may be adapted to be repositioned within the client browser 15. Accordingly, the second item image 20 may be adapted to be superimposed over the first item image 14 and the second image 17. In certain embodiments, the second item content 22 may comprise a garment or a fashion accessory.

The method, in some embodiments, may include the step of generating a compilation image 18 comprising the second image 17 superimposed by both the item image 14 and the second item image 20. The compilation image may be transmitted to one or more users. The second item image 20 may be generated and stored pursuant to equivalent steps that generated the item image 14. The loaded first image 3 may be received from a webpage of a retailer. In some embodiments, the corresponding marks 8 may comprise a third color corresponding to erased portions 23 of the first image 3, where the user actions performed on the first image 3 comprise an erasing action. Further, the user marks may be based on GUI information received from the first window 4, wherein the user actions correspond to GUI information that is partially based on the x-y coordinates 7 of the user marks.

Further, a quick sign-up process may be implemented in certain embodiments to allow users to go into greater detail on their personal “MyProfile” page. The initial user sign-up questions gather photos, favorite retailers, along with data on who a user likes to shop for/shop with, and who they want to share their looks with.

For certain embodiments, benefits to a retailer by partnering with the service provider may include: an increase in the number of shoppers coming to ecommerce sites and the time that the spend on the site; an increase in the utilization of recommendation engines for users to mix and match products; an enhancement in the marketing of products which may target power shoppers as well as new buyers; a platform that enables customers to see, shop, share and buy together even if all are in different physical locations; an integration and customization of such a platform on retail sites; the ability for retailers to update and market their products and to drive individual sales as well as up-sales; an enhanced point of purchase opportunity based on recommendations that mix and match additional items; the capability for users to virtually “try on” items that provides the in-store experience from the comfort of their home or while traveling; improved information that allows a user's purchasing decision to be based on how an item or outfit “fits” a style, event or wardrobe in addition to traditional item size information; the combined ability to express a desired “look” and to receive feedback from friends and family; the capability for members of groups to offer and receive input on a “look” prior to a purchase; an enhanced virtual dressing room that provides a social shopping experience from anywhere in the world with online aggregation of valuable real-time data on shared consumers preferences; and, the ability for retailers to encourage online consumers to visit their physical stores by advertising sales that are available only at local stores. Users can mix and match items they have saved and stored, as well as create brand new looks that may be considered in forecasting fashion trends.

In some embodiments, users may access the present system by going directly to the service provider's website or by downloading the service provider's app. Users may also use web tools or technology via a retail partnership. The service provider may license such tools to retailers so that an implementation may rest directly on the retailer's website. In certain embodiments, preferred retail partners may receive detailed reports, analytics and data. While users can shop from retailers who are not signed-up with the service provider, retailers may not get data unless they are partners, in accordance with certain embodiments of the invention. Reports, analytics and data may be important for stylists (in both fashion and furniture), real estate agents, curators, manufacturers, designers and others. In addition, a recommendation engine and the ability to have a 3D view may be implemented in certain embodiments.

In an embodiment, a user may upload a picture of herself/himself in the sign-up process or they can do so at any time while using the system. Without a picture, users may still see how an item looks by using outline male/female bodies or they can just pull together outfits (dress, shoes, purse, belt, jewelry) without placing these items on a person. Whether the user saves the view of the outfit as seen on a photo of him/her, or on a body outline or without a body, the view may be saved in accordance with certain embodiments of the invention. In certain embodiments, users may view their personal gallery, which may contain all of their saved views, and/or they can share a view in a public gallery on the service provider's website or app.

In some embodiments, after a user has completed the initial sign-up and becomes a member, they can shop at any retailer and use tools to manually edit a picture of a clothing item and place it on themselves for a personalized view. For example, a user may upload a picture of themselves in a tank top and shorts, click on a retail's icon on the service provider's site or app, see a desired dress offered by the retailer, and then drag it to the “try on” area to try out a “look” on the uploaded picture.

In some embodiments, a user can take “pre-curated” retail images provided by the service provider and see how the images (items) look. In the pre-curated process of some embodiments, the service provider may edit images for retailers and users so that shoppers can easily move clothes from a virtual “try on” area into a “dressing room.” This allows for a faster view because of less manual editing time required by the user.

In accordance with certain embodiments, shoppers can see items on themselves as well as see items on people they shop for and shop with. For example, users can see items on their children or on their husbands. User may send their husbands a saved image in three different sports coats and get his feedback on which one he likes. Users may also send a saved image of three different dresses placed in a wish list.

In an embodiment, users can easily share a saved item or share an item saved in their wish list. In certain embodiments, users may share and pair, assigning rights by proxy to other users Implementations may protect privacy by requiring users to get permission to share images of people other than themselves. For example, a user can share with another a picture of themselves in a shirt and pants, but that user may not share a picture of her without permission, in accordance with certain embodiments. Such privacy measures may be implemented to prevent cyber-bullying.

In some embodiments, saved views and wish lists may both be implemented. Also, body outlines or alternative images may be provided. Such images may or may not be avatars, in accordance with certain embodiments. In an embodiment, a user may select from a variety of images in order to match their virtual image to their physical body type and coloring. These images may provide a means of “seeing” an item on if the user does not have a picture of themselves or someone else. The functionality of sharing an image in community, such as friends and family, may be implemented. Further, in certain embodiments, pictures may be searched, sorted and shared. In addition, reports and analytics may be generated to correspond to market research. A recommendation engine may also be available in some embodiments.

In certain embodiments, predictive modeling may be utilized to identify and forecast fashion trends with predictive analytics. Consumer input may be incorporated via algorithms in lieu of reliance on traditional industry intuition-based models. As a result, consumers are enabled to develop their style, and predict and set trends. The modeling may optimize design, creation and purchasing decisions to redefine how, when and why products are paired.

In an embodiment, predictive modeling may be implemented with the disclosed “try on” experience to forecast upcoming fashion trends. For example, the service provider's application or website may allow a manufacturer to determine how they design a coat or a dress and what colors and past styles are most often paired with the item. Predictive modeling may include a determination of users' search terms that result in no items being found to correlate to the search terms, or few items being found, or multiple items being found, and also a determination of the pairing selections performed by users based on search results.

In some embodiments, a comparison feature may be included. A user may view a side-by-side comparison of merchandise to evaluate two or more “looks” that were created by the user to assist in the purchase decision making process. Such comparisons may or may not be shared by the user via email, social media, etc. By sharing a comparison, a user may receive direct feedback on the unique user-generated images that were created. FIG. 6 illustrates two “looks” in a side-by-side comparison.

An embodiment of the present system may include varying hardware components. Many arrangements of components are possible within the scope of the subject matter. Some of the components may be executed in hardware, firmware or computer programmed instructions. Computer programmed instructions may be provided to a processor of a general purpose computer, special purpose computer, application-specific integrated circuit (ASIC), or other programmable data processing apparatus. The instructions, which execute via the processor of the computer or other programmable data processing apparatus, may implement the functions/acts specified in the all or part of the example flow charts illustrated in FIGS. 1-4.

The term “system” shall mean a plurality of components adapted and arranged as indicated. A system may include an inter-connect (e.g., bus and system core logic), which interconnects a microprocessor(s) and memory. The microprocessor may be coupled to cache memory. The inter-connect may interconnect the microprocessor(s) and the memory together and also interconnects them to a display controller and display device and to peripheral devices such as input/output (I/O) devices through an input/output controller(s). Typical I/O devices include mice, keyboards, modems, network interfaces, printers, scanners, video cameras and other devices which are well known in the art. The memory may include ROM (Read Only Memory), and volatile RAM (Random Access Memory) and non-volatile memory, such as hard drive, flash memory, etc.

The term “network” or “computer network” shall mean an electronic communications network adapted to enable one or more computing devices to communicate by wired or wireless signals. Examples of networks include, but are not limited to, local area networks (LANs), wide area networks (WANs) such as the Internet, wired TCP and similar networks, wireless networks (including without limitation wireless networks conforming to IEEE 802.11 and the Bluetooth standards), and any other combination of hardware, computer programmed instructions, and communications capabilities adapted to allow digital communication between computing devices.

The term “server” shall mean a computing device adapted to be operably connected to a network such that it can receive and/or send data to other devices operably connected to the same network, or service requests from such devices. A server has at least one processor and at least one machine-readable storage media operably connected to that processor, such that the processor can read data from that machine-readable storage. The term “operably connected” shall mean connected either directly or indirectly by one or more cable, wired network, or wireless network connections in such a way that the operably connected components are able to communicate digital data from one to another.

Although some of the drawings illustrate a number of operations in a particular order, operations which are not order-dependent may be reordered and other operations may be combined or broken out. While some reordering or other groupings are specifically mentioned, others will be apparent to those of ordinary skill in the art and so do not present an exhaustive list of alternatives.

While the invention has been particularly shown and described with reference to an embodiment thereof, it will be understood by those skilled in the art that various changes in form and details may be made therein without departing from the spirit and scope of the invention.

What is claimed is:

1. A method for controlling online images, comprising the steps of:
loading a first image in a first window, wherein the first image comprises item content and background content;
generating a mask image of the first image, wherein the mask image is displayed in a second window adjacent to the first window, wherein the mask image is grayscale, wherein the mask image has dimensions corresponding to the first image;
receiving x-y coordinates of user marks and user actions performed on the first image in the first window;
generating corresponding marks on the mask image in the second window, wherein the corresponding marks are based on the x-y coordinates of the user marks and the user actions performed on the first image, wherein the corresponding marks comprise a first color corresponding to foreground portions of the first image, wherein the corresponding marks further comprise a second color corresponding to background portions of the first image;
generating one or more resulting blob based on the marked mask image, wherein the one or more resulting blob corresponds to the foreground portions of the first image;
generating an item image based on the one or more resulting blob and the first image, wherein the item image comprises the foreground portions of the first image, wherein the foreground portions correspond to the item content in the first image, wherein the item image comprises the item content; and,
storing the item image.

2. The method of claim 1, wherein the item content comprises a garment.

3. The method of claim 1, further comprising the steps of:
receiving, via a client server, a request for an image associated with the item content;
transmitting the item image to the client server; and,
rendering the item image via a client browser, wherein the item image is adapted to be repositioned within the client browser, wherein the item image is adapted to be superimposed over a second image.

4. The method of claim 3, wherein the second image is a photograph of a person.

5. The method of claim 3, further comprising the step of:
generating a compilation image comprising the item image superimposed over the second image.

6. The method of claim 5, further comprising the step of:
transmitting the compilation image to one or more users.

7. The method of claim 6, further comprising the step of:
receiving feedback from the one or more users, wherein the feedback comprises a critique of the item content.

8. The method of claim 5, wherein the compilation image comprises two or more layers, wherein the first layer is the item image, wherein the second layer is the second image, wherein the layers are adapted to be separated into two or more independent images.

9. The method of claim 8, further comprising the steps of:
storing the compilation image;
removing the item image from the compilation image; and,
generating a second compilation image comprising a second item image superimposed over the second image, wherein the second item image is adapted to be superimposed over the second image.

10. The method of claim 9, further comprising the step of:
rendering, via the client browser, the stored compilation image adjacent to the second compilation image, wherein the two compilation images may be simultaneously viewed for comparison purposes.

11. The method of claim 3, further comprising the steps of:
receiving, via the client server, a second request for an image associated with a second item content;
transmitting a second item image to the client server, wherein the second item image comprises the second item content; and,
rendering the second item image via the client browser, wherein the second item image is adapted to be repositioned within the client browser, wherein the second item image is adapted to be superimposed over the item image and the second image.

12. The method of claim 11, wherein the second item content comprises a garment.

13. The method of claim 11, wherein the second item content comprises a fashion accessory.

14. The method of claim 11, further comprising the steps of:
generating a compilation image comprising the second image superimposed by both the item image and the second item image; and,
transmitting the compilation image to one or more users.

15. The method of claim 11, wherein the second item image is generated and stored pursuant to the steps of claim 1 that generated the item image.

16. The method of claim 1, wherein the loaded first image is received from a webpage of a retailer.

17. The method of claim 1, wherein the corresponding marks comprise a third color corresponding to erased portions of the first image, wherein the user actions performed on the first image comprise an erasing action.

18. The method of claim 1, wherein the user marks are based on GUI information received from the first window, wherein the user actions correspond to GUI information that is partially based on the x-y coordinates of the user marks.

19. The method of claim 1, further comprising the steps of:
executing a graph-cut algorithm based on the marked mask image and the first image, wherein the one or more resulting blob is generated based on output from the executed graph-cut algorithm;
combing the one or more resulting blob into a single foreground blob;
applying the single foreground blob as a mask to the first image;
generating a result image based on the single foreground blob and the first image, wherein the result image renders the foreground portions of the first image, wherein the background portions of the first image are transparent;
calculating a contour image of the foreground portions of the first image; and,
storing the result image and the contour image;

20. The method of claim 1, wherein the first image is identified based on an UPC code.

21. The method of claim 11, wherein an item association is determined based the request for the image associated with the item content and the second request for the image associated with the second item content.

22. The method of claim 1, wherein a purchasing pattern is forecasted based on a plurality of requests for images associated with item content.

23. A non-transitory computer readable medium having computer readable instructions stored thereon for execution by a processor, wherein the instructions on the non-transitory computer readable medium are adapted to:
load a first image in a first window, wherein the first image comprises item content and background content;
generate a mask image of the first image, wherein the mask image is displayed in a second window adjacent to the first window, wherein the mask image is grayscale, wherein the mask image has dimensions corresponding to the first image;
receive x-y coordinates of user marks and user actions performed on the first image in the first window;
generate corresponding marks on the mask image in the second window, wherein the corresponding marks are based on the x-y coordinates of the user marks and the user actions performed on the first image, wherein the corresponding marks comprise a first color corresponding to foreground portions of the first image, wherein the corresponding marks further comprise a second color corresponding to background portions of the first image;
generate one or more resulting blob based on the marked mask image, wherein the one or more resulting blob corresponds to the foreground portions of the first image;
generate an item image based on the one or more resulting blob and the first image, wherein the item image comprises the foreground portions of the first image, wherein the foreground portions correspond to the item content in the first image, wherein the item image comprises the item content; and,
store the item image.

24. A non-transitory computer readable medium having computer readable instructions stored thereon for execution by a processor, wherein the instructions on the non-transitory computer readable medium are adapted to:
receive, via a client server, a request for an image associated with an item content;
transmit an item image to the client server, wherein the item image is generated and stored by the instructions of claim 23; and,
render the item image via a client browser, wherein the item image is adapted to be repositioned within the client browser, wherein the item image is adapted to be superimposed over a second image.

25. A system for controlling online images, comprising:
a server adapted to generate and store a plurality of item images, the server further adapted to transmit at least one of the item images to a client server, wherein the at least one of the item images is generated based on a first image; the first image having foreground portions that comprise item content; and,
a client browser adapted to display the item image transmitted by the server, wherein the item image is adapted to be repositioned within the client browser, wherein the item image is further adapted to be superimposed over a second image.

26. The system of claim 25, further comprising:
a mask image of the first image, the first image loaded in a first window, the mask image generated by the server and displayed in a second window adjacent to the first window, the mask image being grayscale and having dimensions corresponding to the first image;
x-y coordinates of user marks and user actions performed on the first image in the first window;
corresponding marks generated on the mask image in the second window, the corresponding marks based on the x-y coordinates of the user marks and the user actions performed on the first image;
one or more resulting blob corresponding to the foreground portions of the first image, the one or more resulting blob calculated based on the marked mask image; and,
the item image that is generated based on the one or more resulting blob and the first image, the item image comprising the foreground portions generated by the server, the foreground portions correspond to the item content in the first image, the item image comprising the item content.
